(19) United States
(12) Patent Application Publication
(10) Pub. No.: US 2015/0269098 A1
(43) Pub. Date: Sep. 24, 2015

(54) INFORMATION PROCESSING APPARATUS, INFORMATION PROCESSING METHOD, STORAGE, STORAGE CONTROL METHOD, AND STORAGE MEDIUM

(71) Applicant: NEC Corporation, Tokyo (JP)

(72) Inventor: Tomoaki SUGIHARA, Tokyo (JP)

(73) Assignee: NEC Corporation

(21) Appl. No.: 14/659,870

(22) Filed: Mar. 17, 2015

(30) Foreign Application Priority Data
Mar. 19, 2014 (JP) 2014-057066

(51) Int. Cl. G06F 13/18; G06F 13/16

(52) U.S. Cl. CPC G06F 13/18; G06F 13/1694

(57) ABSTRACT

Disclosed is an information processing apparatus which makes it possible to reduce an amount of communication delay. The information processing apparatus includes an issuing unit configured to select a specific controller associated with a logical block, which is to be a target of an input/output process, on the basis of a set of policy information employed by a storage from among a plurality of sets of policy information associating the logical blocks with the controllers, and to send a request about the input/output process to the specific controller.

This application is based upon and claims the benefit of priority from Japanese Patent Application No. 2014-057066, filed on Mar. 19, 2014, the disclosure of which is incorporated herein in its entirety by reference.

### TECHNICAL FIELD

The present invention relates to information processing apparatuses, or the like, which perform processing in conjunction with a storage, such as processing for input/output from/to the storage.

### BACKGROUND ART

Recently, in a data storage (for example, storage array, hereinafter, referred to as “storage”) industry, new technologies, which make it possible to realize a requirement represented by a user on a system, task processing load required in a system, and the like, by performing processing in response to a state of a system, have been appearing one after another. As an example of such technologies, there is a technology to optimally arrange (rearrange) information (data) stored in storage apparatuses (such as, disks) included in a storage. Hereinafter, this technology will be referred to as an “optimum arrangement technology”.

As such a storage apparatus in an information processing system, there are various kinds of storage apparatuses, such as a high-speed storage apparatus and a low-speed storage apparatus. For example, the optimum arrangement technology is a technology for arranging a state of allocation regarding storage areas and the like in accordance with types of storage apparatuses, state of tasks, a variation of a frequency of accesses to a storage apparatus, and/or the like. For example, in such an optimum arrangement technology, a state in which logically configured storage apparatuses (hereinafter, each referred to as a “logical unit”) are allocated to physically configured storage apparatuses (hereinafter, each referred to as a “physical storage apparatus” is changed. Alternatively, in such an optimum arrangement technology, a state of allocation of storage areas storing data in logical units is changed. A processing performance of a system changes in accordance with such a change of a state of allocation of storage areas with the optimum arrangement technology.

In such a system, a server can read only information about the logical units included in a storage. In this case, a server cannot read information about physical storage apparatuses controlled by a storage.

This is because, in such a system, input/output processing is hierarchized into processing performed by a server and processing performed by a storage. That is, a storage controls allocation of logical units to physical storage apparatuses, while a server does not control input/output processing. In such a case where the input/output processing is hierarchized into processing performed by a server and processing performed by a storage, even when a failure occurs in a physical storage apparatus included in the storage, the server does not control any input/output processing on the physical storage apparatus. As a result, processing load on the server is reduced.

Further, as an input/output processing method about a storage, there is an asymmetric logical unit access (ALUA) technology. This ALUA technology is a technology which, when making a plurality of logical units each associated with a corresponding one of a plurality of controllers (for example, disk controllers) each for controlling a plurality of physical storage apparatuses, selects and determines a controller, which has a high priority in controlling the logical units, from among the controllers. Hereinafter, such a controller having a high priority will be referred to as a high-priority controller. In a system employing this technology, a server sends a request about input/output processing to the high-priority controller.

When a storage includes a plurality of controllers, the storage may be configured such that a plurality of controllers perform control of one logical unit. In this case, a controller which controls the logical unit does not necessarily control all physical storage apparatuses allocated to the logical unit.

As described above, in the case where a controller controlling a logical unit (for convenience of description, this controller will be referred to as a “first controller”) is different from a controller controlling a physical storage apparatus allocated to the logical unit (for convenience of description, this controller will be referred to as a “second controller”), the first controller and the second controller need to communicate with each other in case of two controllers. As a result, a processing performance of the storage is degraded to a level lower than that of a case where the first controller and the second controller are the same because a communication between the first controller and the second controller is required.

Hereinafter, examples of general technologies in relation to a storage will be described.

An apparatus disclosed in patent literature 1 (Japanese Patent Application Publication No. 2003-131818), stores data via a communication network when storing data in a storage having a cluster configuration. This apparatus does not replicate the data on cache memory, and thus, alleviates the degradation of the utilization efficiency of the cache memory.

A data transfer apparatus disclosed in patent literature 2 (Japanese Patent Application Publication No. 2000-259502) includes a first node receiving a request including data to be stored in a storage as well as a second node different from the first node. The first node receives a request, and sends data included in the request to the second node. The second node receives the data, and subsequently sends an acknowledge message to the first node having sent the request.

A storage system disclosed in patent literature 3 (Japanese Patent Application publication No. 2003-5920) is configured to rearrange logical units to minimize a period of time between inputting of a request and starting of processing of the request in accordance with an M/M/1 queuing theory.

### SUMMARY OF INVENTION

### Technical Problem

As described, when a storage includes a plurality of controllers, a high priority controller controlling is a logical storage is selected from among the plurality of controllers. Each controller controlling the logical units controls a plurality of physical storage apparatuses under the each controller itself.

In this case, a server (an information processing apparatus or an input/output processing apparatus) sends a request for requesting the high-priority controller to perform an input/output process. Even when the high-priority controller does not control a physical storage apparatus which is expected to perform the requested input/output process, the server sends the request to the high-priority controller.

In this case, the high-priority controller communicates a different controller which controls the physical storage apparatus and performs the requested input/output process in accordance with a request. Thus, in this case, communication arises between the two controllers and, as a result, communication delay occurs.

Accordingly, a main object of the present invention is to provide an information processing apparatus or the like reducing an amount of communication delay.

An information processing apparatus or the like in accordance with some aspects of the present invention alleviates an amount of communication delay.

### SUMMARY

As one aspect of the present invention, an information processing apparatus according to the present invention includes

an issuing unit configured to select a specific controller associated with a logical block, which is to be a target of an input/output process, on the basis of a set of policy information employed by a storage from among a plurality of sets of policy information associating the logical blocks with the controllers, and to send a request about the input/output process to the specific controller.

As another aspect of the present invention, information processing method of the present invention is:

selecting a specific controller associated with a logical block, which is to be a targeted of an input/output process, on the basis of a set of policy information employed by a storage from among a plurality of sets of policy information associating the logical blocks with the controllers, and sending a request about the input/output process to the specific controller.

The object may also be attained by using a computer program, as well as a computer-readable recording medium storing the computer program, to cause a computer to implement an event correlation detection apparatus having the above configuration and a corresponding method.

### BRIEF DESCRIPTION OF THE DRAWINGS

Exemplary features and advantages of the present invention will become apparent from the following detailed description when taken with the accompanying drawings in which:

FIG. 1 is block diagram showing a configuration of the information processing apparatus according to a first exemplary embodiment of the present invention;

FIG. 2 is a flowchart showing a flow of processing performed by the information processing apparatus according to the first exemplary embodiment;

FIG. 3 is a diagram conceptually showing the logical unit information;

FIG. 4 is a flowchart showing processing performed by the storage when the storage makes a logical unit;

FIG. 5 is a diagram conceptually showing an example of the policy information which is referred to when controllers are allocated in accordance with logical addresses;

FIG. 6 is a diagram conceptually showing an example of the policy information which is referred to when controllers are allocated in accordance with logical addresses;

FIG. 7 is a diagram conceptually showing example of policy information which are similar to policy information shown in FIG. 8;

FIG. 8 is a diagram conceptually showing example of policy information which are similar to policy information shown in FIG. 7;

FIG. 9 is a block diagram showing a configuration of the storage according to a second exemplary embodiment of the present invention;

FIG. 10 is a flowchart showing a flow of processing performed by the storage according to the second exemplary embodiment;

FIG. 11 is sequence diagram showing a process flow in the storage and in an information processing apparatus, according to the second exemplary embodiment;

FIG. 12 is a diagram conceptually showing an example of response information;

FIG. 13 is block diagram showing a configuration of the information processing system according to a third exemplary embodiment of the present invention;

FIG. 14 is the block diagram schematically illustrating the hardware configuration of a computer processing apparatus that can implement the information processing apparatus according to the first exemplary embodiment or the storage according to the second exemplary embodiment;

### EXEMPLARY EMBODIMENT

The exemplary embodiments of the present invention will be described in detail below with reference to the drawings.

### First Exemplary Embodiment

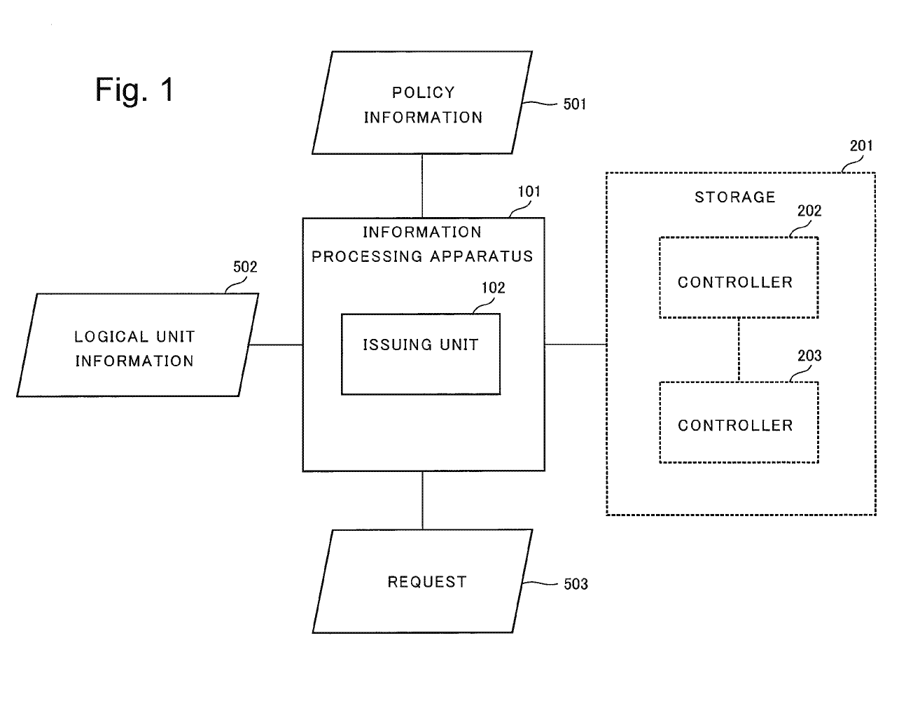

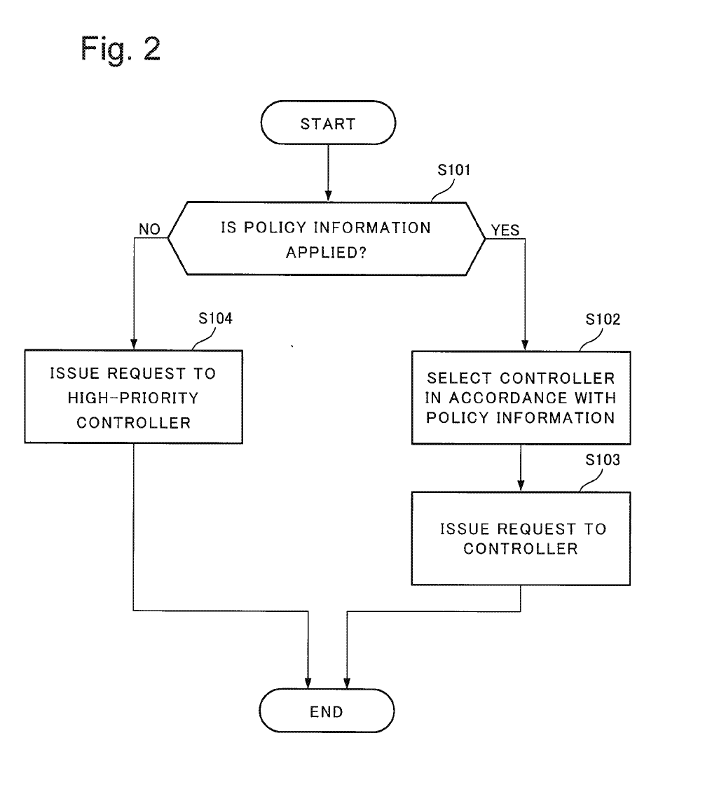

A configuration of an information processing apparatus 101 according to a first exemplary embodiment of the present invention and processing performed by the information processing apparatus 101 will be described in detail with reference to FIGS. 1 and 2. FIG. 1 is block diagram showing a configuration of the information processing apparatus 101 according to the first exemplary embodiment of the present invention. FIG. 2 is a flowchart showing a flow of processing performed by the information processing apparatus 101 according to the first exemplary embodiment.

The information processing apparatus 101 according to the first exemplary embodiment includes an issuing unit 102.

Hereinafter, for convenience of description, it is assumed that, in response to a request, a data storage (for example, storage array, hereinafter, referred to as “storage”) 201 performs input/output processing in accordance with policy information 501. Further, in this exemplary embodiment, it is assumed that an address used in a logical unit is represented by a logical block addressing (LBA) method. A method for describing an address, however, is not limited to this LBA method. This is also similar in individual exemplary embodiments described below.

First, the policy information 501 will be described.

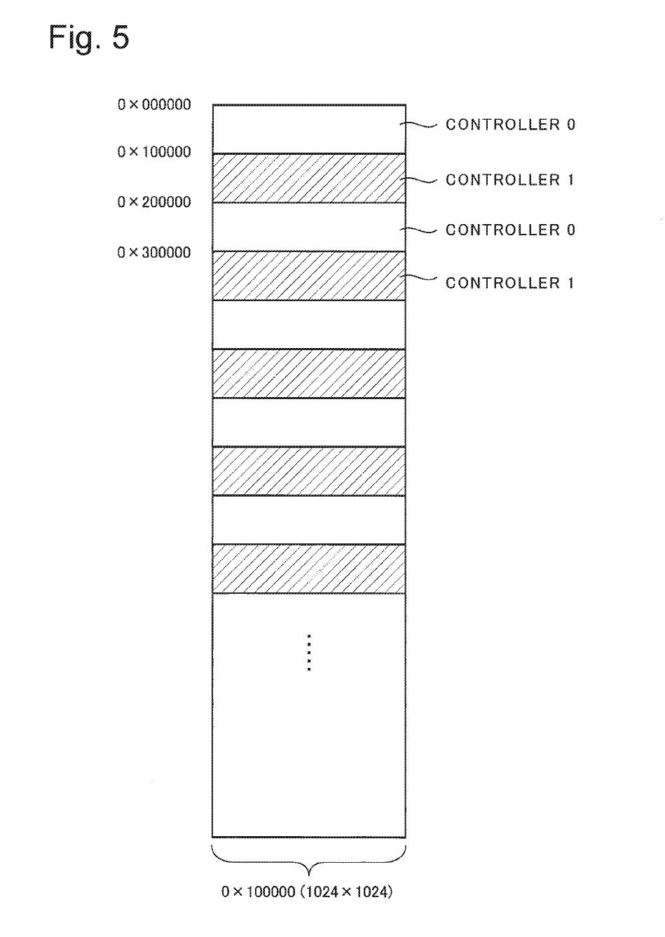

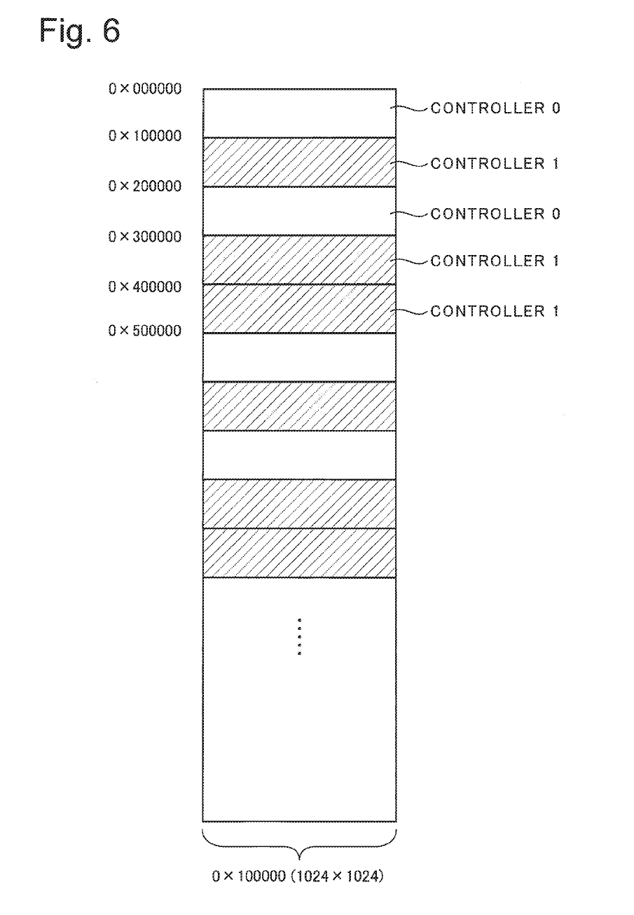

As shown in FIGS. 5 and 6, the policy information 501 is, for example, a set of information referred to when controllers for the respective logical blocks are allocated in accordance with logical addresses indicating a part of storage areas of a logical unit. Hereinafter, these storage areas being referred to as “logical blocks”. FIGS. 5 and 6 are diagrams conceptually showing an example of the policy information 501 which is referred to when controllers are allocated in accordance with logical addresses.

For example, the policy information 501 identifies controllers for the logical blocks in accordance with logical addresses indicating the start of a logical blocks (hereinafter, these logical addresses being referred to as “start addresses”). In addition, the policy information 501 does not necessarily include information for identifying storage areas of physical storage apparatus controlled by controllers.

For example, as shown in following policy information 1 to 3, the policy information 501 is a set of information for deciding controllers of the logical blocks based on quotient of the start address by one mebibyte (MiB).

Policy Information 1 (FIG. 5):

When the quotient is an even number, a controller 0 is allocated as a controller of a corresponding logical block (a plain area in FIG. 5). In contrast, when the quotient is an odd number, a controller 1 is allocated as a controller of a corresponding logical block (a shaded area in FIG. 5). That is, in accordance with the policy information 1, logical blocks of a logical unit are equally allocated to each of the controllers in a unit of one MiB.

Policy Information 2 (FIG. 6):

When a remainder resulting from dividing the quotient by “5” is “0” or “2”, the controller 0 is allocated as a controller of a corresponding logical block (a plain area in FIG. 6). Further, when the remainder is “1” or “3”, the controller 1 is allocated as a controller of a corresponding logical block (a shaded area in FIG. 6). That is, in accordance with the policy information 2, the logical blocks of the logical unit are unequally allocated to the controllers in a unit of one MiB.

Policy Information 3:

When a remainder resulting from dividing the quotient by a number “4” is “0”, the controller 0 is allocated as a controller of a corresponding logical block. When the remainder is “1”, the controller 1 is allocated as a controller of a corresponding logical block. When the remainder is “2”, a controller 2 is allocated as a controller of a corresponding logical block. When the remainder is “3”, a controller 3 is allocated as a controller of a corresponding logical block. That is, in accordance with the policy information 3, the logical blocks of the logical unit are equally allocated to the controllers in a unit of one MiB.

The storage 201 (or the information processing apparatus 101) is capable of selecting a controller of the each logical block in accordance with the policy information 501.

For example, an example where a controller of the each logical block is selected in accordance with the policy information 1 will be described in detail with reference to FIG. 5.

In the example shown in FIG. 5, one logical block has a size of 1 MiB. For example, a quotient resulting from dividing a start address “0x000000” of a logical block from an address “0x000000” to an address “0x100000” by 1 MiB is “0”(i.e., an even number), and thus, a controller 0 is allocated to the logical block from the address “0x000000” to the address “0x100000”. In addition, “x” included in an address means a hexadecimal number.

Similarly, a quotient resulting from dividing a start address “0x300000” of a logical block from an address “0x300000” to an address “0x400000” by 1 MiB is “3”(i.e., an odd number), and thus, a controller 1 is allocated to the logical block from the address “0x300000” to the address “0x400000”.

Further, an example where a controller of the logical block is selected in accordance with the policy information 2 will be described in detail with reference to FIG. 6

In an example shown in FIG. 6, one logical block has a size of 1 MiB. For example, a remainder obtained by dividing a quotient (=“0”) resulting from dividing a start address “0x000000” of a logical block from an address “0x000000” to an address “0x100000” by 1 MiB is “0”, and thus, a controller 0 is allocated to the logical block from the address 0x000000 to the address 0x100000.

Similarly, a remainder obtained by dividing a quotient (=“3”) resulting from dividing a start address “0x300000” of a logical block from an address “0x300000” to an address “0x400000” by 1 MiB is “3”, and thus, a controller 1 is allocated to the logical block from the address 0x300000 to the address 0x400000.

In the case of small computer system interface (SCSI), up to 256 kinds (sets) of policy information can be defined as the policy information 501. In the case where the set of policy information 501 has a plurality of sets, the storage 201 selects a set of policy information 501, and then selects a controller of the each logical block in accordance with the selected policy information 501.

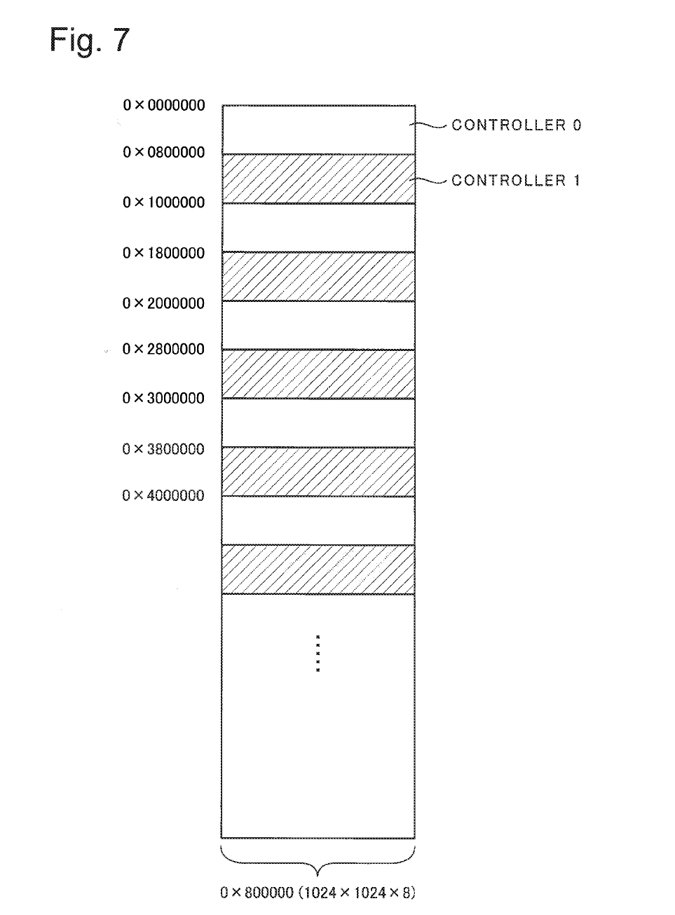

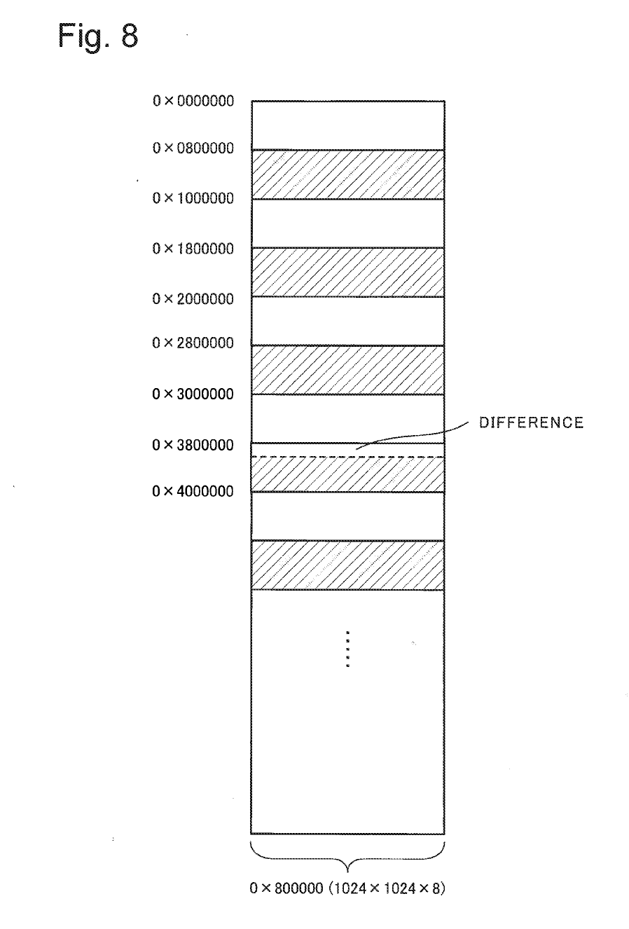

Further, as shown in examples of FIGS. 7 and 8, in order to reduce a load of processing for optimum arrangement (rearrangement) in the storage 201, it is desirable to define, in advance, a plurality of sets of policy information 501 resembling one another. FIGS. 7 and 8 are diagrams conceptually showing examples of two policy information resembling each other.

A set of policy information 4 shown in FIG. 7 and a set of policy information 5 shown in FIG. 8 are examples of such policy information resembling each other. For example, in the case of the policy information 501, in which a controller of the each logical block is selected in accordance with a remainder obtained by dividing a quotient resulting from dividing a start address of the each logic block by 1 MiB, the policy information 4 and the policy information 5 can be obtained in such a way as described below.

The Policy Information 4 (FIG. 7):

In the case where the remainder is any one of “0” to “7”, “16” to “23”, “32” to “39”, and “48” to “55”, a controller 0 is allocated to a corresponding logical block (a plain area in FIG. 7). Further, in the case where the remainder is any one of “8” to “15”, “24” to “31”, “40” to “47”, and “56” to “63”, a controller 1 is allocated to a corresponding logical block (a shaded area in FIG. 7).

The Policy Information 5 (FIG. 8):

in the case where the remainder is any one of “0” to “7”, “16” to “23”, “32” to “39”, and “48” to “55”, the controller 0 is allocated to a corresponding logical block (a plain area in FIG. 8). Further, in the case where the remainder is any one of “8” to “15”, “24” to “31”, “40” to “47”, and “57” to “63”, the controller 1 is allocated to a corresponding logical block (a shaded area in FIG. 7).

There is a difference between the policy information 4 and the policy information 5 in a controller of a logical block corresponding to the remainder is “56” (this logical block being an area denoted by “difference” in FIG. 8). That is, when a policy information is changed from the policy information 4 to the policy information 5, a controller controlling a logical block corresponding to the remainder is “56” (i.e., the area denoted by “difference” in FIG. 8) is changed from the controller 0 to the controller 1 among sixty-four logical blocks. That is, when a policy information is changed from the policy information 4 to the policy information 5, an allocation of a controller to a logical block equivalent to one sixty-fourth of all the logical blocks is changed.

The policy information 1 to 5 mentioned above are examples of a case where the controllers is allocated (selected) by using a hash function on the basis of a start address of each logical block. As a different method for selecting a controller of the each logical block, on the basis of a start address of the each logical block, for example, a consistent hash technique may be employed.

In addition, the policy information 501 may be, for example, a method for selecting controllers on a sector basis. The policy information 501 may be a method for selecting a controller of a sector (hereinafter, referred to as a “logical sector”) in accordance with a quotient resulting from dividing a start address of the logical sector by “250” in the case where a sector size is 4096. The following set of policy information 6 is an example of policy information 501, each of which is a means for determining, for each logical sector, a controller that controls the each logical sector.

The Policy Information 6:

In the case where the quotient is an even number, a controller 0 is allocated as a controller of a corresponding logical sector. In the case where the above quotient is an odd number, a controller 1 is allocated as a controller of a corresponding logical sector.

In addition, examples of a representation method for realizing the policy information 501 include a method of writing conditional formula by a script language, and a method of writing conditional formula by an extensible markup language (XML). Further, parameters referred to in the conditional formula are, for example, a start address of a logical block, a size of the logical block, and the like. These parameters are, for example, parameters referred to when a read buffer command and a write buffer command related to SCSI is executed. The above-described script language and XML are general technologies, and thus, detailed description thereof is omitted in this exemplary embodiment.

Hereinafter, for convenience of description, it is assumed that the information processing apparatus 101 and the storage 201 recognize the policy information 501 by policy identifiers to uniquely identify a corresponding policy information 501. The policy identifier may be a number or a symbol. Further, it is assumed that the information processing apparatus 101 and the storage 201 share the policy identifiers. That is, it is assumed that a policy information identified by a certain policy identifier is identical to a policy information identified by the policy identifier in the information processing apparatus 101 as well as a policy information identified by the policy identifier in the storage 201. Further, it is assumed that the policy information 501 read by the information processing apparatus 101 which desires to process a logical block, is the latest policy information having been applied to the logical block by the storage 201.

For example, in the case where the storage 201 has processed a logical block, the storage 201 updates a policy information 501 applied to the logical block Alternatively, the information processing apparatus 101 may receive a policy information 501 with respect to a logical block targeted for processing from the storage 201. Further, in the case where the information processing apparatus 101 and the storage 201 share the policy identifiers, the policy information 501 may be represented by the policy identifiers.

Next, processing performed by the information processing apparatus 101 according to this exemplary embodiment will be described.

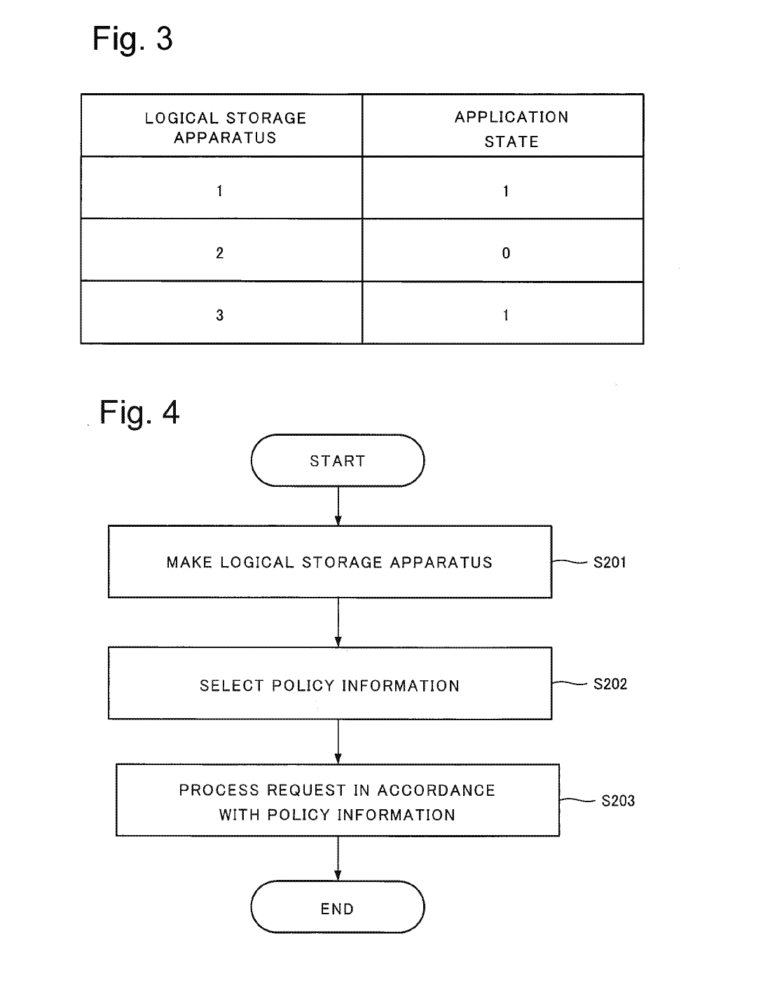

First, the issuing unit 102 decides whether or not a logical unit targeted for processing is a target for applying policy information 501 (step S101). For example, the issuing unit 102 decides whether or not a logical unit targeted for processing is a target for applying policy information 501 by referring to a logical unit information 502 exemplified in FIG. 3. FIG. 3 is a diagram conceptually showing the logical unit information 502.

Referring to FIG. 3, in the logical unit information 502, for example, a logical unit 1 is associated with an application state “1”. This means that the logical unit 1 is a target for applying the policy information 501 since an application state associated with the logical unit 1 is “1”. Further, in the logical unit information 502, for example, a logical unit 2 is associated with an application state “0”. This means that the logical unit 2 is not a target for applying the policy information 501 since an application state associated with the logical unit 2 is “0”.

The information processing apparatus 101 makes the logical unit information 502 in advance based on information related to the storage 201. In addition, the information processing apparatus 101 may update the logical unit information 502 based on whether or not the storage 201 applies the policy information 501 to the logical unit. Moreover, the logical unit information 502 may further include information which a logical unit is associated with a policy identifier applied to the logical units. For example, the information processing apparatus 101 makes the logical unit information 502 by receiving information associating with a logical units and an application state related to the logical unit from the storage 201.

For example, when processing whose target is a logical unit 1 is performed, the issuing unit 102 reads an application state associated with the logical unit 1 from the logical unit information 502. Next, the issuing unit 102 decides whether or not the logical unit 1 is a target for applying the policy information 501 on the basis of the read application state (step S101). In the example shown in FIG. 3, since an application state associated with the logical unit 1 is “1”, the issuing unit 102 decides that the logical unit 1 is a target for applying the policy information 501.

If the issuing unit 102 decided that the logical unit is not a target for applying the policy information 501 (NO in step S101), the issuing unit 102 sends the request 503 to a high-priority controller of the storage 201 (step S104).

In contrast, if having decided that the logical unit is a target to for applying the policy information 501 (YES in step S101), the issuing unit 102 determines (selects) a specific controller controlling a target logical block, on the basis of a start address of the target logical block in accordance with the policy information 501 (step S102).

Next, the issuing unit 102 sends the request 503 indicating processing related to the target logical block to the selected specific controller (step S103). In this case, for example, it is assumed that this selected specific controller is a controller 202.

In addition, it is assumed that the storage 201 makes the logical unit before receiving the request 503 from the information processing apparatus 101. Here, a method in accordance of which the storage 201 makes a logical unit will be described with reference to FIG. 4. FIG. 4 is a flowchart showing processing performed by the storage 201 when the storage 201 makes a logical unit.

The storage 201 makes a pool (a storage pool) operating as a logical unit by unifying one or more physical storage apparatuses (step S201). That is, the storage 201 arranges (or rearranges) a logical unit on one or more physical storage apparatuses.

Next, after a logical unit constituted of one or more physical storage apparatuses has been made, a controller of the storage 201 selects a specific policy information (i.e., policy information 501) from among a plurality sets (kinds) of policy information (step S202). Next, the storage 201 determines (selects) a specific controller processing the logical block in accordance with policy information 501. For example, the storage 201 determines a specific controller processing the each logical block in accordance with any one of the aforementioned first to sixth sets of policy information. That is, in the storage 201, a configuration for processing each of the logical blocks is determined.

For a method for making a logical unit with one or more physical storage apparatuses, that is, a method for making a pool, various methods are already known, and thus, detailed description is omitted here.

Next, processing when the controller 202 receives the request 503 will be described.

First, the controller 202 receives the request 503 sent by the information processing apparatus 101. Next, the controller 202 carries out input/output processing in accordance with the received request 503 (step S203).

The storage 201 may output policy information which is applied when processing a logical block related to the input/output processing as policy information 501. Alternatively, the storage 201 may send the policy information 501 to the information processing apparatus 101 as a response to the request 503.

Next, advantageous effects brought by the information processing apparatus 101 according to the first exemplary embodiment will be described.

In accordance with the information processing apparatus 101 of this exemplary embodiment, an amount of communication delay in the storage 201 can be reduced.

It is because a specific controller controlling a physical storage apparatus storing a logical block which is a target for processing on the basis of the request 503 is highly likely to coincide with the controller 202 to which the information processing apparatus 101 sends the request 503. This is because the issuing unit 102 determines a controller to which the request 503 is sent on the basis of the latest policy information followed by the storage 201.

As described above, when the controller 202 is different from a specific controller (for example, a controller 203) processing a logical block related to the request 503 in the storage 201, communication arises between the controller 202 and the controller 203. In contrast, when these two controllers are the same, no communication occurs between these two controllers. The issuing unit 102 sends the request 503 to the controller 202 on the basis of the latest policy information followed by the storage 201, and thus, the controller 202 is highly likely to coincide with the specific controller processing a logical block related to the request 503 in the storage 201. In this case, no communication occurs between these two controllers.

Meanwhile, the apparatus disclosed in patent literature 3 sends a request without referring to policy information followed by a storage. That is, the controller 202 is unlikely to coincide with the controller 203. Accordingly, in the apparatus, as compared with the information processing apparatus 101 according to this exemplary embodiment, communication is more highly likely to arise between the controller 202 and the controller 203. As a result, in accordance with the apparatus, it is difficult to efficiently perform processing in the storage.

In addition, although, in the above description, the issuing unit 102 has calculated a controller on the basis of a start address, the start address is not necessarily used, and, for example, a logical address indicating the end of a logical block may be used.

Further, in the case where the information processing apparatus 101 and the storage 201 share policy identifiers and policy information, the information processing apparatus 101 may include a policy storage unit (not illustrated) capable of storing the policy identifiers and the policy information such that each of the policy identifiers is associated with policy information. In the case where the storage 201 sends a policy identifier instead of policy information corresponding to the policy identifier, the information processing apparatus 101 may read the policy information from the policy storage unit in which policy information is associated with the sent policy identifier.

### Second Exemplary Embodiment

The following describes a second exemplary embodiment, which is based on the first exemplary embodiment described above.

The following description mainly focuses on specific features according to this exemplary embodiment, and the same configuration as that in the first exemplary embodiment described above is denoted by the same reference numerals, redundant explanation of which is omitted.

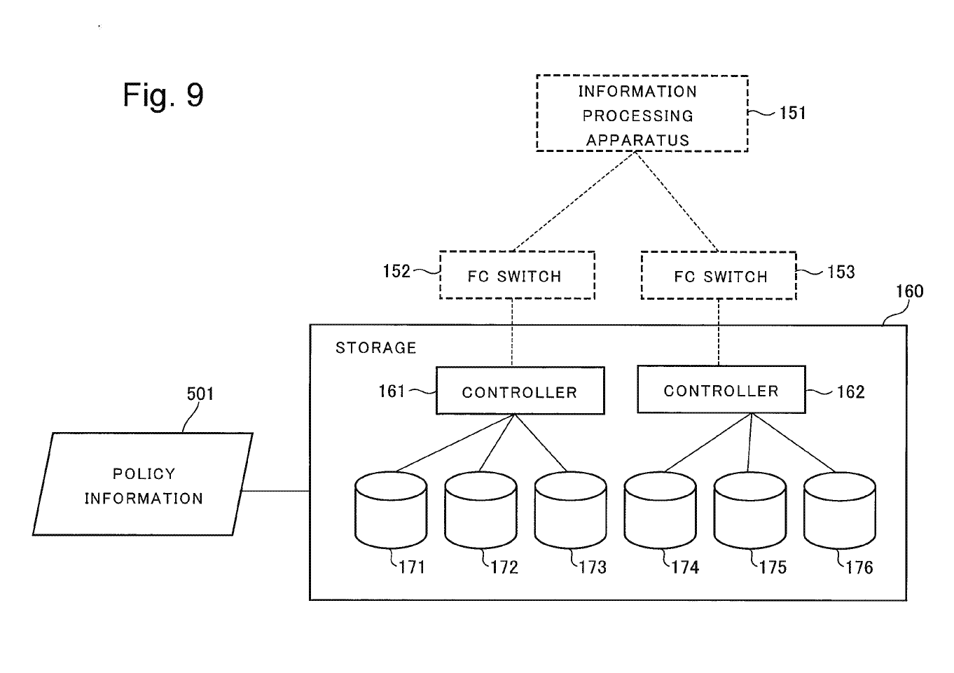

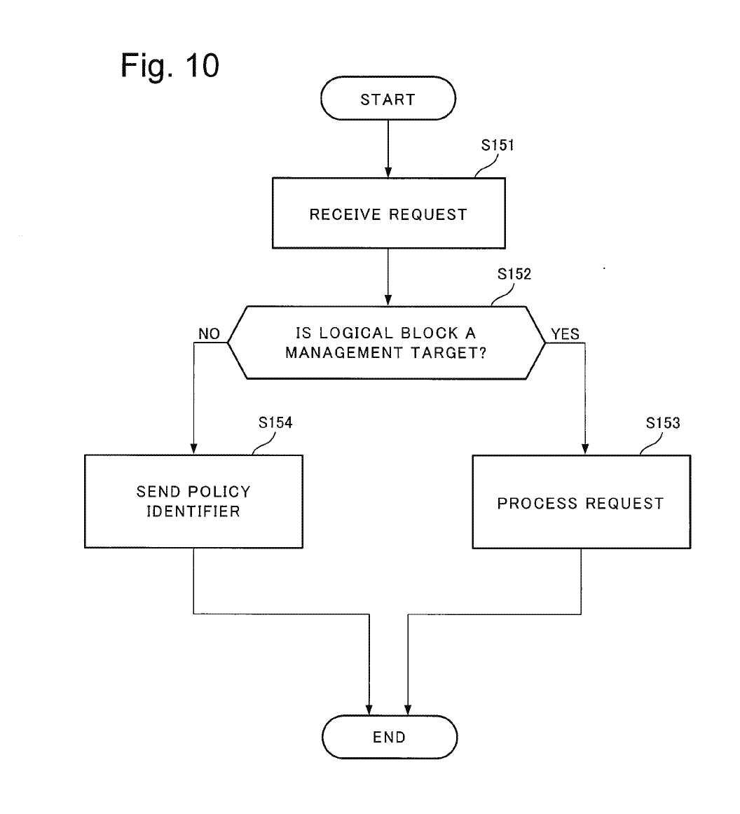

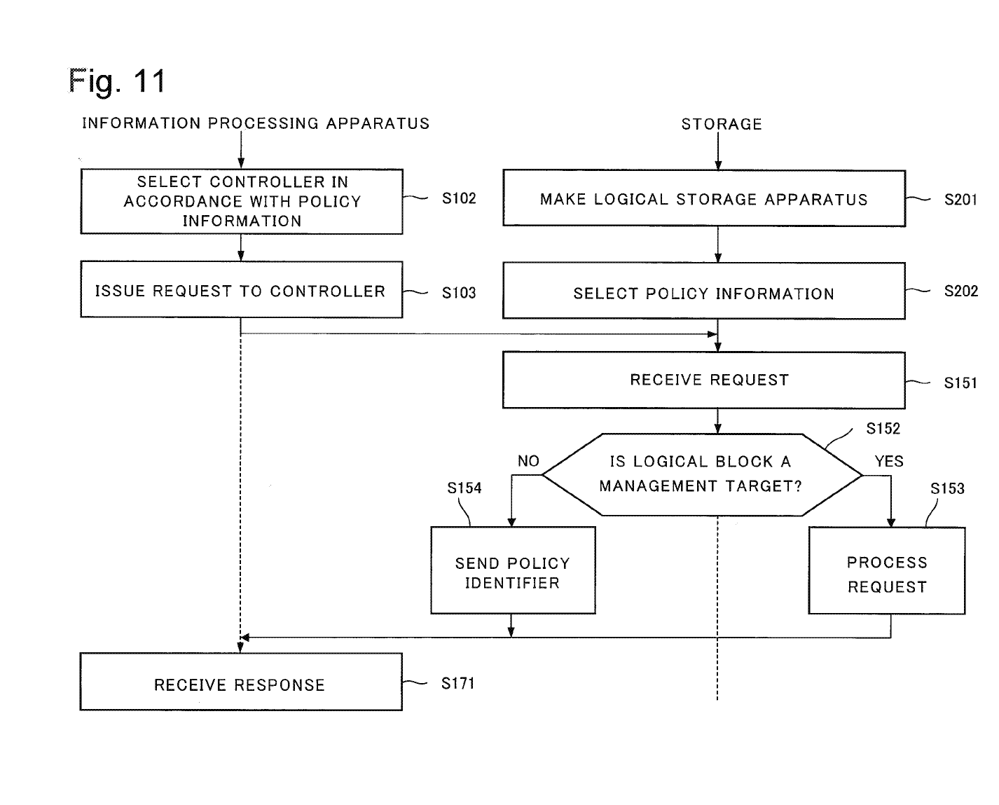

A configuration of a storage 160 according to the second exemplary embodiment as well as processing performed by the storage 160 will be described with reference to FIGS. 9 to 11. FIG. 9 is a block diagram showing a configuration of the storage 160 according to the second exemplary embodiment of the present invention. FIG. 10 is a flowchart showing a flow of processing performed by the storage 160 according to the second exemplary embodiment. FIG. 11 is sequence diagram showing a process flow in the storage 160 and in an information processing apparatus 151, according to the second exemplary embodiment.

The storage 160 according to the second exemplary embodiment includes a controller 161, a controller 162, and physical storage apparatuses 171 to 176.

The controller 161 controls the physical storage apparatus 171, the storage apparatus 172, and the storage apparatus 173. Further, the controller 162 controls the physical storage apparatus 174, the storage apparatus 175, and the storage apparatus 176.

Further, for example, the controller 161 is capable of sending/receiving information to/from the information processing apparatus 151 via a fiber channel (FC) switch 152. Similarly, the controller 162 is capable of sending/receiving information to/from the information processing apparatus 151 via a FC switch 153.

For convenience of description, it is assumed that the number of physical storage apparatuses controlled by the controllers 161 and 162 is three, but the number of physical storage apparatuses is not necessarily to be three. The controller 161 and the controller 162 may control a larger number of physical storage apparatuses or may control a smaller number of physical storage apparatuses. Further, the controller 161 and the controller 162 may control mutually different numbers of physical storage apparatuses.

Referring to FIG. 11, the controller 161 and the controller 162 makes logical units (step S201) and selects policy information 501 which is a basis of the control of the logical units (step S202). Thereafter, the controllers 161 and 162 receive the request 503 (step S151).

Here, for convenience of description, it is assumed that the controller 161 receives the request 503 from the information processing apparatus 151 via the FC switch 152.

The controller 161 decides whether or not a logical block which is a target for processing related to the received request 503 is allocated to the physical storage apparatus to be controlled by the controller 161 itself (i.e., the physical storage apparatuses 171 to 173), on the basis of the policy information 501 and the like (step S152). For example, the controller 161 selects a specific controller controlling a logical block on the basis of a start address of the logical block which is a target for processing in accordance with a READ command or a WRITE command, which is an example of the request 503.

The controller 161 decides whether or not the selected specific controller is the controller 161 itself. In the case where the selected specific controller is the controller 161 itself, the controller 161 controls a physical storage apparatus allocated to the logical block which is a target of the processing. That is, control on the logic block which is a target of the processing is allocated to the controller 161.

In the case where the controller 161 controls the logical block which is a target of the processing (YES in step S152), the controller 161 performs processing in accordance with the request 503 (step S153).

Further, the controller 161 may send specific policy information 501 for selecting the specific controller in the storage 160 to the information processing apparatus 151.

Meanwhile, in the case where the controller 161 itself does not control the logical block which is a target of the processing (NO in step S152), the controller 161 sends a policy identification indicating specific policy information applied to the target logical block which is a target of the storage 160 to the information processing apparatus 151 (step S154). In this case, the controller 161 may update current policy information 501 into new policy information applied to the target logical blocks of the storage 160. Further, the controller 161 send the policy identifier and the information processing apparatus 151 may receive the policy identifier (step S171). In this case, the information processing apparatus 151 updates current policy information 501 into new policy information identified by the policy identifier.

After the update to the latest policy information 501, the information processing apparatus 151 selects the controller 161 on the basis of the latest policy information 501.

Further, in a system according to this exemplary embodiment (that is, in a system including the storage 160 and the information processing apparatus 151), during “NO” in step S152, the processes of step S101, step S102, step S103, step S151, step S152, and step S154 may be repeatedly executed.

Moreover, in the system according to this exemplary embodiment, in response to execution of rearrangement, the processes of step S101, step S102, step S103, step S151, step S152, step S153, and step S154 may be repeatedly executed.

For example, the controller 161 may make response information to the request 503 by setting “Status_code” indicating a reply about SCSI to “GOOD” (i.e., “00h”, wherein “h” represents that a relevant number is a hexadecimal number) and may send the response information to the information processing apparatus 151.

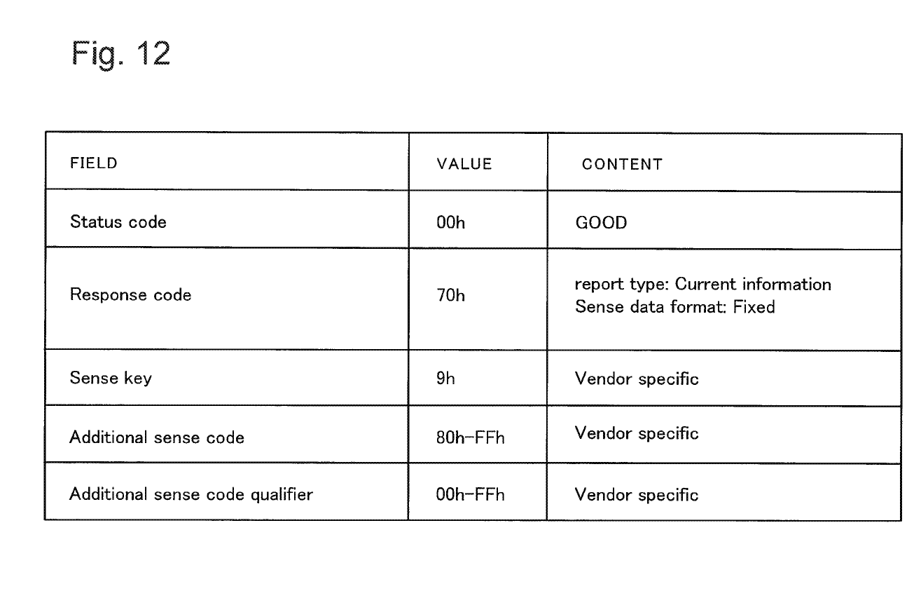

The controller 161 may further add “Sense_data” to the above response information. For example, in “Sense_data”, the controller 161 sets “Response_code” to “70h”. Moreover, as shown in FIG. 12, the controller 161 may set a policy identifier identifying the latest set of policy information in any one of areas which are contained in the response information and each of which indicates a corresponding one of “Additional_sense_code” and “Additional_sense_code_qualifier”. FIG. 12 is a diagram conceptually showing an example of response information.

As shown in FIG. 12, “Sense_data” indicating the response information includes “Status_code”, “Response_code”, “Sense_key”, “Additional_sense_code”, and “Additional_sense_code_qualifier”.

As described above, it becomes unnecessary for the controller 161 to respond anew to the information processing apparatus 151 by making response information including a policy identifier. Thus, the controller 161 becomes capable of responding to the request 503 more efficiently.

Even though a result of the process in step S152 is “NO”, the storage 160 is required to correctly deal with and respond to the request 503. Thus, the storage 160 sets “Status_code” in the response information to “GOOD”. Even though the information processing apparatus 151 is different from the information processing apparatus as shown in the first exemplary embodiment, the information processing apparatus 151 receives response information where “Status_code” is “GOOD” from the storage 160. In this case, the information processing apparatus 151 decides that there is no problem in the storage 160 in accordance with the response information including “GOOD”.

Next, advantageous effects brought by the storage 160 according to the second exemplary embodiment will be described.

According to the storage 160 of this exemplary embodiment, in addition to the advantageous effects in the first exemplary embodiment, an amount of a communication delay can be reduced to a greater degree.

Reasons for this are such as described in reason 1 and reason 2 below.

(Reason 1)

The information processing apparatus 151 has the same advantageous effects as those having been described in the first exemplary embodiment.

(Reason 2)

A policy identifier is sent/received between the information processing apparatus 151 and the storage 160 instead of a set of policy information having a size much larger than that of the policy identifier.

Generally, the larger the size of a sent/received information is, the larger an amount of communication delay of the information is. Since a policy identifier has several bytes of information at most, the size of the policy identifier is very small. Accordingly, an amount of communication delay in this exemplary embodiment is further smaller than that in the aforementioned exemplary embodiment.

### Third Exemplary Embodiment

The following describes a third exemplary embodiment, which is based on the first exemplary embodiment described above.

The following description mainly focuses on specific features according to this exemplary embodiment, and the same configuration as that in the first exemplary embodiment described above is denoted by the same reference numerals, redundant explanation of which is omitted.

An information processing apparatus 181 according to the third exemplary embodiment is realized by hardware components.

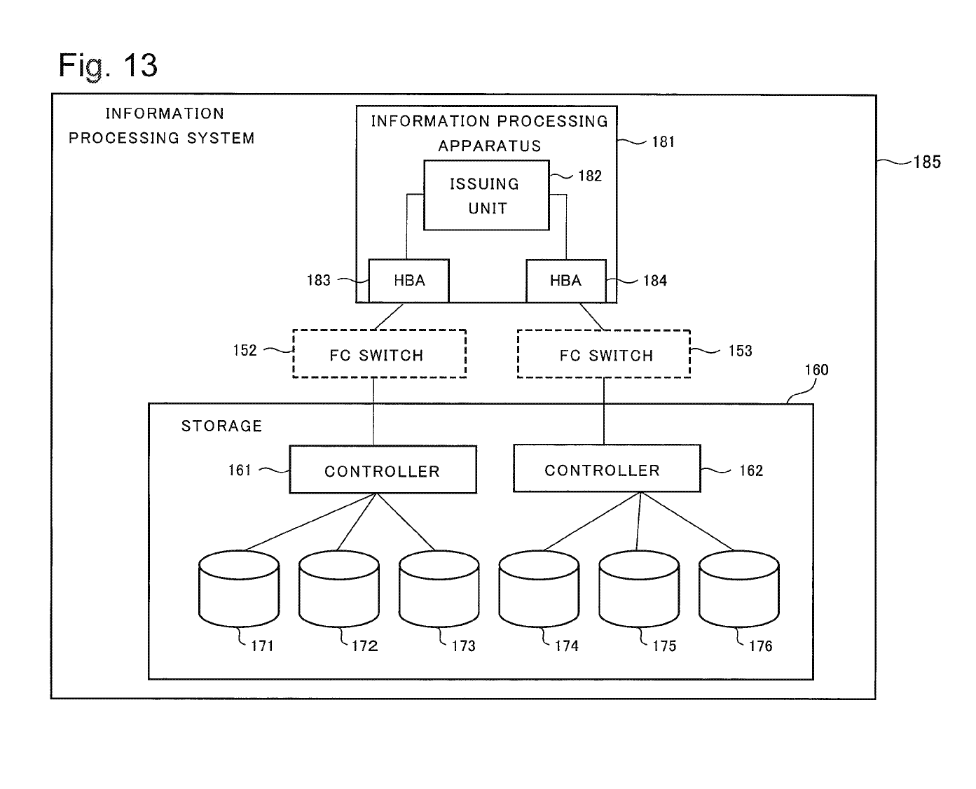

A configuration of an information processing system 185 according to the third exemplary embodiment as well as processing performed by the information processing apparatus 181 will be described with reference to FIG. 13. FIG. 13 is block diagram showing a configuration of the information processing system 185 according to the third exemplary embodiment of the present invention.

The information processing system 185 according to the third exemplary embodiment includes the information processing apparatus 181, an FC switch 152, an FC switch 153, and a storage 160. The information processing apparatus 181 is capable of sending/receiving information to/from the storage 160 via each of the FC switch 152 and the FC switch 153.

The information processing apparatus 181 includes an issuing unit 182, a host bus adapter (HBA) 183, and a HBA 184.

The issuing unit 182 sends the request 503 to the plurality of HBAs (interface cards). When a logical unit is a target for applying policy information 501, the HBA 183 (HBA 184) sends the request 503 to a controller 161 (controller 162) of the logical unit via the FC switch 152 (FC switch 153). When the logical unit is not a target for applying policy information 501, the HBA 183 (HBA 184) does not send the request 503 to the controller 161 (controller 162) of the logical unit.

When input/output processing operates in accordance with multi-path software which designates a plurality of paths, the information processing apparatus 181 sets a controller to send the request 503 to the HBAs, and sends the request 503 to drivers for controlling each HBA.

Upon reception of the request 503, the HBA 183 (HBA 184) refers to a start address of a logical block to be processed in accordance with the request 503. Next, the HBA 183 (HBA 184) decides whether or not the start address is an address included in logical blocks controlled by the controller 161 (controller 162). When having decided that the start address is included in the logical blocks, the HBA 183 (HBA 184) sends the request 503 to the controller 161 (controller 162) via the FC switch 152 (FC switch 153). When having decided that the start address is not included in the logical blocks, the HBA 183 (HBA 184) does not send the request 503 to the controller 161 (controller 162). When the HBA 183 (HBA 184) has sent the request 503 to the controller 161 (controller 162), the HBA 183 (HBA 184) sends information for notifying a normal completion of sending the request 503 (for example, in the case of Linux (registered trademark), DID OK is set in host byte) to the information processing apparatus 181. The multi-path software completes input/output processing when having received information notifying that all processes on the plurality of paths have been normally completed. In contrast, in the case where there is any path on which the process has not been normally completed, the multi-path software performs error handling on the input/output processing similarly to error handling on the process on the path.

Further, when the functions are realized by using software, processing having been described in each of the above exemplary embodiments is executed by the software.

Next, advantageous effects brought by the information processing system 185 according to the third exemplary embodiment will be described.

In accordance with the information processing system 185 according to the third exemplary embodiment, an amount of communication delay in the storage 160 can be reduced.

A reason for this is that the configuration of the information processing system 185 according to the third exemplary embodiment encompasses the configuration of the information processing apparatus according to the first exemplary embodiment and the configuration of the storage according to the second exemplary embodiment. As a result, the information processing system 185 brings the advantageous effects similar to the effects described in the individual aforementioned exemplary embodiments.

(Exemplary Hardware Configuration)

The following describes an exemplary configuration of hardware resources for implementing the information processing apparatus according to the first exemplary embodiment and the storage according to the second exemplary embodiment using a single computer processing apparatus (information processing apparatus, or a computer). It should be noted, however, that the event correlation detection system may be implemented using at least two types, either physical or functional, of computer processing apparatuses. In addition, the event correlation detection system may be implemented in the form of a dedicated apparatus.

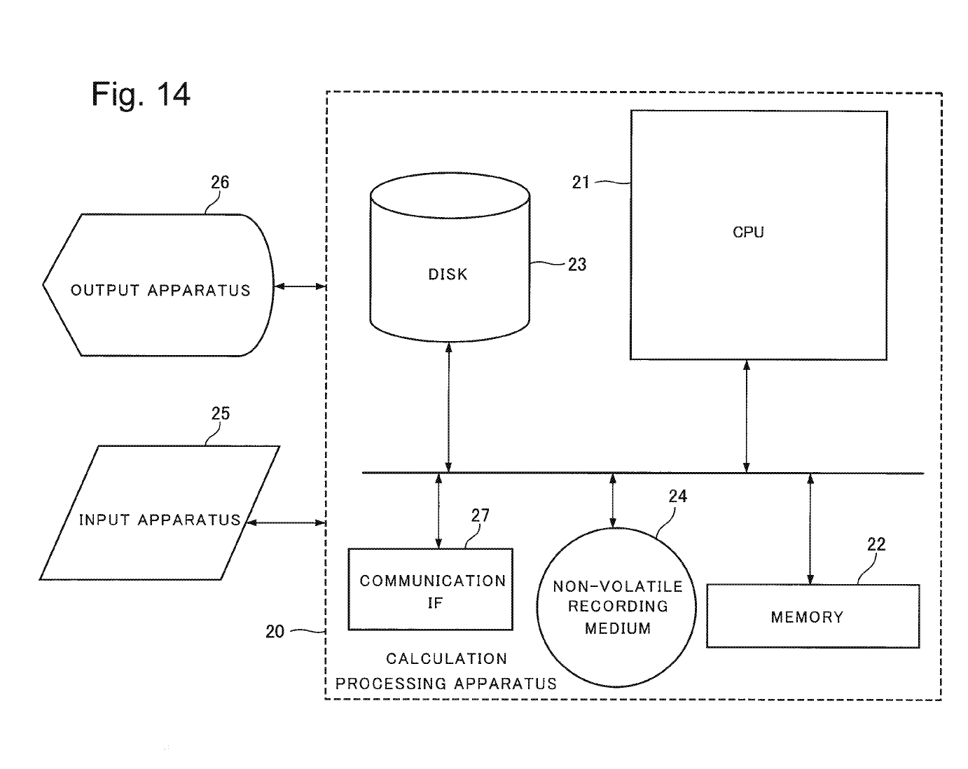

FIG. 14 is the block diagram schematically illustrating the hardware configuration of a computer processing apparatus that can implement the information processing apparatus according to the first exemplary embodiment or the storage according to the second exemplary embodiment. The computer processing apparatus 20 includes a central processing unit (CPU) 21, a memory unit 22, a disk 23, an output apparatus 26, an input apparatus 25, a non-volatile recording medium 24 (which may be hereafter referred to as “recording medium”) and communication interface (here after referred to as “communication IF”) 27. The computer processing apparatus 20 can communicate another computer processing apparatus or a communication apparatus via the communication IF 27.

The non-volatile recording medium 24 may be any medium that can be read by a computer. The non-volatile recording medium 24 is, for example, a portable medium that is capable of retaining a relevant program in the absence of power supply. For example, the examples of the non-volatile recording medium 24 may include the following media:
compact disc;
digital versatile disc (DVD); and
universal serial bus (USB) memory unit.

The above media is portable and capable of retaining such a program without power supply.

The non-volatile recording medium 24 is not limited to the above-mentioned media. In place of the non-volatile recording medium 24, such a program may be carried via the communication IF 27.

When executing the software program (computer program: hereafter simply referred to as a “program”) stored in the disk 23, the CPU 21 copies the program into the memory unit 22 and performs arithmetic processing. The CPU 21 reads data necessary for execution of the program from the memory unit 22. The CPU 21 displays the output result on the output apparatus 26 when necessary. When the program is externally loaded, the CPU 21 reads the program from the input apparatus 25. The CPU 21 interprets an information processing program or a storage control program the in the memory unit 22 and executes the program. The CPU 21 performs the processing in a sequence in accordance with the flowcharts (FIGS. 2, 4, and 10), which have been referred in the above-described exemplary embodiments.

Accordingly, in such a case, it can be appreciated that the present invention may be implemented by the information processing program or by the storage control program. It can further be appreciated that the present invention may be implemented by a computer-readable recording medium storing the information processing program or the storage control program.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

1. An information processing apparatus comprising:
an issuing unit configured to select a specific controller associated with a logical block, which is to be a target of an input/output process, on the basis of a set of policy information employed by a storage from among a plurality of sets of policy information associating the logical blocks with the controllers, and to send a request about the input/output process to the specific controller.

2. A storage comprising:
a controller configured to send a specific set of policy information which is employed in selecting a specific controller controlling a logical block included in a request including a target of an input/output process among a plurality of sets of policy information associating logical blocks and controllers.

3. An information processing system comprising:
the information processing apparatus according to claim 1; and
the storage according to claim 2,
wherein the controller sends a policy identifier identifying the specific set of policy information employed by the storage to the information processing apparatus, and
the issuing unit sends the request based on the specific set of policy information which is identified by the policy identifier sent by the controller.

4. The information processing system according to claim 3, wherein
the information processing apparatus further includes a policy storing unit configured to store the policy identifier sent by the controller into a memory unit, and
the issuing unit configured to read the policy identifier from the memory unit and to send the request in accordance with the set of the policy information identified by the read policy identifier.

5. The information processing system according to claim 3, wherein
in a case where a physical storage apparatus controlled by the controller includes the logical block included in the request, the controller performs a process in accordance with the request, and
in a case where the physical storage apparatus does not include the logical block included in the request, the controller sends the policy identifier identifying the specific set of policy information employed by the controller.

6. The information processing system according to claim 3, further comprising:
a policy information storage unit configured to be capable of storing the sets of policy information associated with the policy identifier wherein
the issuing unit configured to read the set of policy information associated with the policy identifier sent by the controller from the policy information storage, and to select the controller based on the read set of policy information.

7. An information processing method comprising:
selecting a specific controller associated with a logical block, which is to be a target of an input/output process, on the basis of a set of policy information employed by a storage from among a plurality of sets of policy information associating the logical blocks with the controllers, and sending a request about the input/output process to the specific controller.

8. A storage control method comprising:
sending a specific set of policy information employed in selecting a specific controller which controls a logical block included in a request including a target of an input/output process among a plurality of sets of policy information associating logical blocks and controllers.

9. A storage medium that stores therein an information processing program which causes a computer to execute processing comprising:
an issuing function configured to select a specific controller associated with a logical block, which is to be a target of an input/output process, on the basis of a set of policy information employed by a storage from among a plurality of sets of policy information associating the logical blocks with the controllers, and to send a request about the input/output process to the specific controller.

10. A computer-readable recording medium that stores therein a storage control program which causes a computer to execute processing comprising:
a controlling function configured to send a specific set of policy information which is employed in selecting a specific controller controlling a logical block included in a request including a target of an input/output process among a plurality of sets of policy information associating logical blocks and controllers.
